(19) United States
(12) Patent Application Publication
(10) Pub. No.: US 2007/0207022 A1
(43) Pub. Date: Sep. 6, 2007

(54) Modular caddy load-handling trailer docking system

(76) Inventor: Robert J. Simmons, Hayward, CA (US)

Correspondence Address: ROBERT D. VARITZ, P.C., 4915 SE 33RD PLACE, PORTLAND, OR, 97202, US

(21) Appl. No.: 11/714,534

(22) Filed: Mar. 5, 2007

Related U.S. Application Data
(60) Provisional application No. 60/779,516, filed on Mar. 6, 2006.

(51) Int. Cl. B65G 67/02

(52) U.S. Cl. 414/572

(57) ABSTRACT

A modular caddy load-handling trailer docking system including (a) a ground-traveling trailer having an elongate, upright, longitudinal and generally planar rack-beam including upper, elongate hook-rail structure, and (b) a selectively dockable/undockable, modular load-carrying caddy adapted to receive a transportable load, and having both (1) a free-standing, separated-from-trailer, ground-support configuration, and (2) hook structure adapted for enabling hook-docking of the caddy, via the hook structure, on the rack-beam's hook-rail structure for transport by and with the trailer.

### CROSS REFERENCE TO RELATED APPLICATION

This application claims priority to the filing date, Mar. 6, 2006, of currently co-pending U.S. Provisional Patent Application Ser. No. 60/779,516, covering an invention entitled “Modular Caddy Load-Handling Trailer System”. The entire disclosure content of that prior-filed Provisional Application is hereby incorporated herein by reference.

### BACKGROUND AND SUMMARY OF THE INVENTION

This invention relates to a caddy and trailer system including a selectively trailerable/free-ground-standable upright caddy for holding, handling, and transporting loads, such as loads of panel-configured construction objects, like plural-story building-structure surfacing skin panels. This system is also referred to herein as a modular caddy load-handling trailer docking system. As will be seen, the features and functionality of the invention are not necessarily dedicated, and/or limited, to the handling of such construction objects, though a preferred and best-mode embodiment of the invention is illustrated and described herein in conjunction with such panel-like objects with respect to which the invention has been found to offer particular utility.

It is more and more a common experience today in the construction of buildings, such as plural-story buildings, to deliver at least partially pre-fabricated building components, such as building surfacing-skin panel structures, to building sites. Such components are typically pre-fabricated in the controlled environment of an “off-building-site” facility wherein quality control, and particularly dimensional-precision quality control, is more easily implemented and effected. Often, though certainly not always, groups, or families, of related components are preferably assembled into a common delivery group so that they arrive at a building site in appropriate proximate relationships to one another.

Once located on such a site, and with respect to these kinds of components, it is often the case that grouped components must be temporarily stored/staged until their “assembly time” arrives. When that time arrives, they must then be delivered appropriately (i.e. accurately, quickly and conveniently) to the location where they are to be integrated into an emerging building. Where a plural-story building is involved, such components will often need to be lifted and maneuvered to the specific building regions which are their respective construction destinations.

Thus, several important, operative considerations which bear upon the satisfactory handling of such components include: (a) ease and convenience of transport from pre-fabrication site to building site; (b) ease and convenience of “on-building-site” storage/staging; and (c) ease and convenience of maneuvering into building assembly locations.

The present invention uniquely and very satisfactorily addresses all of these considerations.

Proposed by the present invention, in relation to addressing these several considerations, is a modular caddy load-handling trailer docking system including a ground-traveling trailer usable in conjunction with one or more removably, gravity-hookable/dockable load-transporting (or carrying) caddies, which preferably attach and detach (dock and undock) to and with the trailer in what is referred to herein as a side-saddle manner. The various specific features of trailer and caddy constructions will be expressed more fully below, but at this point in the disclosure of this invention, it is important to point out that the proposed caddy structure is one which not only can be docked (as generally expressed above) easily on the trailer structure, but which can also sit as a free-standing load-holding unit on the ground, either at the site where building components that are to be carried to a building site have been, for example, pre-fabricated, as well as in a staging and storing location selected on a building site per se for the storage of pre-introduction building components.

The structure of the present invention is characterized by extremely simple and relatively lightweight configurations for the trailer structure per se, and for the caddy structure per se, with the caddy and trailer structures being uniquely designed to handle a relatively wide variety of load sizes easily and conveniently. Additionally, and with respect to a loaded caddy which is attached removably to the proposed trailer, the load of the caddy, and of whatever load components it carries, is delivered as a vertical gravity load which acts in a laterally central plane downwardly into the main frame of the trailer, whereby all transported loads are thereby held by the trailer for transport over the ground in extremely stable conditions, with good, lateral load balancing in place with respect to how the trailer main frame delivers a load to the ground.

These and other features and advantages offered and provided by the system of this invention will now become more fully apparent as the detailed description thereof which follows below is read in conjunction with the accompanying drawings.

### DESCRIPTION OF THE DRAWINGS

FIG. 1 is an isometric frontal view of a trailer made in accordance with the present invention, disconnected from any towing tractor, and illustrated in relation to a pair of load-handling caddies. All of this structure is built in accordance with a preferred and best mode embodiment of the present invention, with one of the caddies in this figure being shown in a trailer-disconnected status, free-standing on the ground, and without any load being illustrated in this caddy in order better to see the structure of the caddy, and the other caddy being shown in a condition carrying a load (shown in phantom lines) in a condition side-saddle gravity-hooked onto the illustrated trailer for transport with the trailer.

FIG. 2 is a high-level, fragmentary, schematic view generally illustrating all of the features of the invention in a manner somewhat simplified in order to emphasize the working relationships between components in the invention.

FIG. 3 is a fragmentary cross section taken generally orthogonally relative to the long axis of trailer and caddy structure illustrating, in somewhat greater detail, the hooked and securely anchored condition of a caddy on the trailer of the invention, such as the condition illustrated for the “near” caddy in FIG. 1 in the drawings.

### DETAILED DESCRIPTION OF THE INVENTION

Directing attention now to all of the drawings, a first set of matters to note is that components illustrated therein are not necessarily drawn to scale. Also, the exact details of structural configurations, except with regard to certain, clearly identified, generally stated elements of the present invention, are not critical, and may be varied, as is additionally true with respect to sizes, to suit different load-handling use applications.

Notwithstanding these several comments, one form of a preferred and best-mode embodiment of the invention is illustrated and described herein in the context of handling relatively large, generally planar, panel-structure loads designed for off-building-site fabrication for (a) delivery, (b) pre-installation staging where appropriate, and (c) ultimate incorporation into a building frame, such as a plural-story building frame. Included, as will be described shortly, is an elongate, tractor-towable, ground-traveling trailer having an illustrative length herein of about 48-feet, and an elongate, open-framework caddy, having (a) an illustrative length herein of about 17-feet, (b) an illustrative height herein of about 10-feet, and (c) an illustrative lateral width herein of about 4-feet.

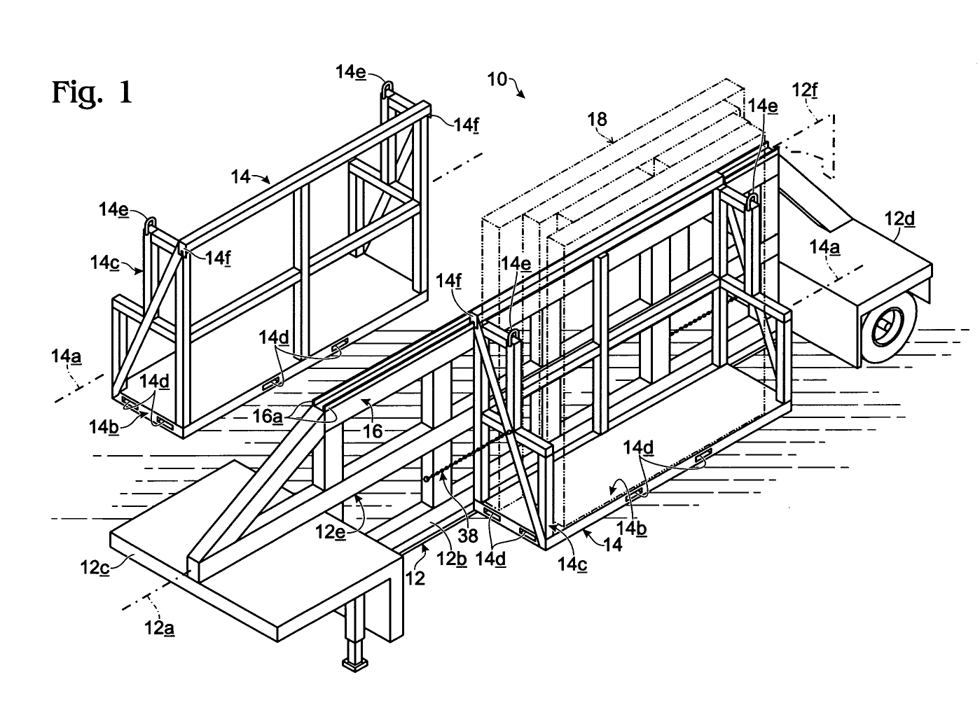

Indicated generally at 10 in the drawings is what is referred to herein as a modular caddy load-handling trailer docking system including, as was just suggested above, an elongate, ground-traveling trailer 12 with a laterallu central long axis 12a, and an elongate, load-carrying caddy 14 (two caddies are shown in FIG. 1) having a long axis 14a.

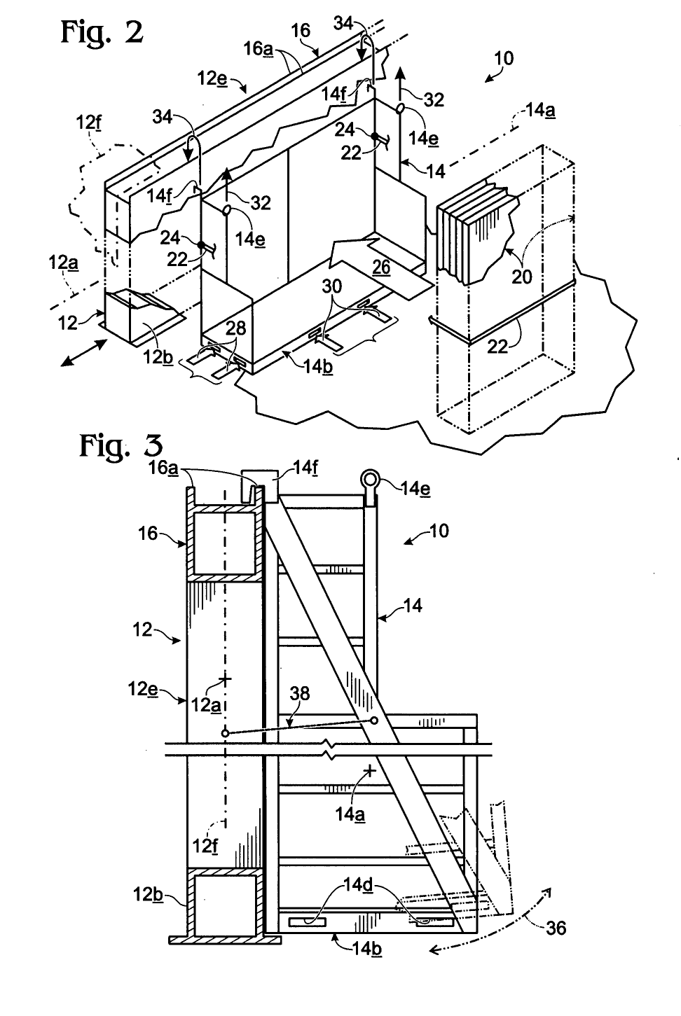

Trailer 12 includes an elongate, tractor-towable, main ground-traveling frame 12b having a front, towing end 12c (see especially FIG. 1) and a rear, wheel-suspension-supported end 12d (see also especially FIG. 1). Rising generally laterally centrally and upwardly from main frame 12b is a central upright, longitudinal and generally planar, load-supporting rack-beam structure, or rack-beam 12e which, adjacent its top, carries/includes a longitudinally elongate, elevated, generally horizontal hook-rail structure 16. Hook-rail structure 16 is also referred to herein as a top portion of rack beam 12e. Rack-beam 12e and hook-rail structure 16 lie, generally speaking, in an upright plane 12f which is normally oriented as a vertical plane (and is so referred to herein), which plane is laterally centered with respect to the overall width of trailer 12. Plane 12f contains previously mentioned trailer long axis 12a. Plane 12f is shown fragmentarily in dash-dot lines in FIGS. 1 and 2, and is illustrated by a single dash-dot line in FIG. 3.

Hook-rail structure 16, which has a generally upwardly facing, somewhat channel-shaped configuration possesses a pair of elongate, laterally spaced, evenly and generally parallel-disposed rails 16a which symmetrically straddle plane 12f, and which are designed to receive, on opposite lateral sides of the rack-beam structure, two or more gravity-hooked, “side-saddle”-disposed caddies 14. In FIG. 1, where two caddies are shown, the “near” caddy is illustrated in a condition side-saddle gravity-hooked, or docked, in place on the “near” side of trailer 12, and the “far” caddy is shown unhooked, or undocked, and free-standing on the ground, on the “far” side of, and separated from, the trailer. This condition for the caddy is referred to herein as a free-standing, separated-from-trailer, ground-support configuration for this caddy. Thus, the caddy of this invention possesses what is referred to herein as a free, ground-standing capability.

With respect to the attached (docked) condition of a caddy with respect to trailer 12, it is important to note that, preferably, such a caddy may be positioned at any suitable location along the available length of the trailer, and on either side of the trailer. In other words, there are no specific docking stations which are defined for the caddy of this invention, and this condition promotes a high degree of versatility with respect to caddies of different sizes (i.e. lengths) which might be employed to carry different kinds of loads. It is also important to note that with respect to load delivery through the frame of the trailer and ultimately to the ground, such a load is effectively transmitted centrally downwardly, essentially within plane 12f. A consequence of this is that a loaded trailer carrying caddies, in accordance with practice of this invention, is substantially always well-stabilized and balanced with respect to caddy loads delivered to it, and through it to the ground.

As was mentioned earlier herein, the various structural features and components of the present invention may be built in a number of different ways in order to handle different kinds of loads. For the purpose of illustration herein, system 10 has been constructed, and is illustrated, in a condition especially designed for the handling of pre-fabricated building-panel structures that have been pre-fabricated at a site which is remote from the building site, which structures are ultimately to be transported by the system of the invention, and handled in other ways which will be explained shortly, for ultimate installation in a building, such as on the outside of an emerging building frame for a plural-story building. In this context, in FIGS. 1 and 2 two representative loads are shown at 18, 20, respectively, with load 18 in FIG. 1 being illustrated substantially entirely in phantom lines in order that this load will not conceal trailer and caddy structural elements, and with load 20 in FIG. 2 being shown partially in solid lines, and partially in phantom lines.

As was mentioned earlier herein, the full details of construction pictured in the drawing figures for trailer 12 and caddies 14 are not especially relevant to the present invention, can be organized in a number of different ways to suit different load-handling conditions, and are thus not described herein in detail. Suffice it to say that the structures illustrated for the trailer and the caddies herein are well representative of structural arrangements for these system components which may be used for flat panel loads such as loads 18, 20.

Accordingly, and turning attention to each of the two caddies illustrated herein, these caddies have a relatively open framework construction as pictured, including a base deck 14b upwardly from which rises a riser frame 14c in a manner which gives each caddy what can be thought of as a open, lateral, outer side for the free receipt and removal of loads, and with end profile configurations which are generally L-shaped, at least from one end point of view. Provided appropriately on the four sides (i.e. end and lateral) of each of the caddy decks are lift-fork-receiving passages such as those shown at 14d. These passages, which are also referred to herein as accommodation structure, accommodate the receipt and withdrawal of lift forks for the purpose of picking up and handling a caddy with or without a caddy-supported load present.

Provided generally laterally centrally adjacent the opposite upper ends of each caddy are pick hooks 14e, referred to herein as elevated pick structure, which accommodate(s) overhead crane picking, maneuvering and otherwise handling of a caddy, loaded or otherwise.

Also furnished adjacent the opposite ends and the tops of each caddy, on what may be referred to as their laterally inner sides, are downwardly facing gravity-operating hooks, or hook-structures, 14f which are designed for gravity lowering onto and hooking-docking with respect to rails 16a in trailer 12. The gravity-hooked-and-docked condition of a caddy with respect to a rail 16a is illustrated both in FIG. 1 and in FIG. 3.

Describing now how the system of the present invention may be employed, and starting this description in relation to the site of prefabrication of load components, such as the panel components which make up loads 18, 20 in the figures, one or more caddies is/are made available at the relevant prefabrication site, with these caddies typically sitting normally disconnected from any trailer, and resting on an underlying ground support surface, as appropriate. When a load of components is to be placed in a caddy, in any suitable manner, the load and the caddy are brought together, as for example, by fork-lifting, or crane-lifting, of the caddy to bring it close to where load components are ready for loading, and the relevant load of pre-fabricated building components is suitably placed in a condition resting on the caddy's deck.

When a complete load has been established on this deck, the load is suitably bound to the caddy to stabilize it in any suitable fashion, as by conventional load banding by end-anchored releasable strapping, such as that shown generally at 22 in schematic FIG. 2. In FIG. 2, strapping 22 is shown only fragmentarily. While it forms no part of the present invention, it will typically be the case that suitable anchor points for this kind of strapping, such as anchor points 24 shown in FIG. 2, will be provided at appropriate locations on the riser frame structures in the caddies. Such loading action for load components onto the deck in the caddy is illustrated generally by broad arrow 26 in FIG. 2.

Such a loaded caddy at the site of component prefabrication may then simply be left in place as a storage unit where the caddy acts, in effect, as a storage cassette for its contained load, and preferably will sit in place there in a ground-supported condition detached from any trailer. It may, of course, after loading, be maneuvered into a suitable staging or storage area at the prefabrication site, either by lifting and maneuvering with a forklift device, as is illustrated generally by pairs of arrows 28, 30 in FIG. 2, or by picking up and maneuvering via an overhead crane which operates with pick hooks 14e, as is generally illustrated by the two arrows shown at 32 in FIG. 2.

When it is time for a caddy-held load to be transported to a building site, trailer 14, under the driving influence of a coupled tractor, is maneuvered to an appropriate location at the prefabrication site, and one or more caddies is/are maneuvered, again by lift-fork operation or by overhead-crane operation, to cause hooks 14f to be lowered by gravity so as to become caught and gravity docked with a rail 16a in the trailer. Such lowering and hooking activity is illustrated schematically in FIG. 2 generally by reverse-bend arrows 34 in this figure.

In the hooked and docked (by gravity) condition of a caddy relative to a side of trailer 12, the caddy is said to be side-saddle docked on and with the trailer, with the entire load of the caddy delivered downwardly generally in plane 12f through the central trailer structure, and with the lower part of each caddy generally swingable back and forth with respect to the trailer, as is illustrated by double-headed dash-double-dot arrow 36 in FIG. 3. This illustration in FIG. 3, highlighted by arrow 36, helps to point out the fact that the load of the caddy, and of whatever is bound to it as a building-component load, is truly supported simply through hook and rail engagement near the top of trailer 12.

Once a caddy has been side-saddle docked with respect to the trailer, appropriate conventional chain binding is utilized between appropriate attaching structures provided on a caddy and on the trailer to bind the caddy against lateral swinging and for riding substantially as a tightly bound unit with respect to the trailer. Such a binding is illustrated generally at 38 in the figures, and may be entirely conventional in construction and in choice for placement.

A loaded trailer with loaded caddies is then transported to the relevant building site, and the process just described with respect to loading and docking of the caddies with respect to the trailer is then carried out in substantially reverse order. Namely, utilizing overhead crane structure or lift-fork structure, and after unbinding of the caddies with respect to the trailer, the caddies are lifted and removed from the trailer, and are then appropriately placed on the ground at a location where they may continue to serve as building component storage cassettes, and as staging units, prior to the time when their respective loads are to be discharged and assembled into an emerging building. When that time comes, once again each caddy is picked up and maneuvered by overhead crane operation or lift-fork operation to shift the loaded caddy to an appropriate location for discharging of its load. The respective load components are then unbound from each caddy, and in any suitable conventional manner are maneuvered to their intended assembly locations within a building structure.

Accordingly, a preferred embodiment of an invention has been described which offers a unique system for the handling, maneuvering and storing of various kinds of loads, utilizing load-handling caddies which can be side-saddle docked and undocked by gravity on a slender elongate trailer central structure wherein all carried loads are delivered in a laterally centralized and balanced condition through trailer structure to the ground. Loads carried by caddies can remain with caddies at times when it is important to keep load components together in a staging-for-use condition, or otherwise, with the relevant caddies under these circumstances being freely ground-standable in stable conditions, ready to be picked up and maneuvered for subsequent load-handling as desired.

It will be evident to those skilled in the art that the key features of this invention may be embodied in a wide range of structures specifically configured to handle different kinds of loads. It will also be apparent that side-saddle docking and undocking to utilize the proposed relationship between a transported trailer and caddies offers a very simple approach for load handling. Further, it will be evident that multiple caddies may be carried on the opposite sides of the central structure in a given trailer, and also that multiple caddies may be distributed, side-saddle, along each single lateral side of the proposed trailer structure.

Accordingly, while a preferred and best mode embodiment of the invention has been illustrated and described herein, it is appreciated that variations and modifications may be made without departing from the spirit of the invention.

I claim:

1. A modular caddy load-handling trailer docking system comprising
a ground-traveling trailer having an elongate, upright, longitudinal and generally planar rack-beam including upper elongate hook-rail structure, and
a selectively dockable/undockable, modular load-carrying caddy adapted to receive a transportable load, and having both a free-standing, separated-from-trailer, ground-support configuration, and hook structure adapted for enabling hook-docking of the caddy, via the hook structure, on the rack-beam's hook-rail structure for transport by and with the trailer.

2. The system of claim 1, wherein said rack-beam is disposed generally laterally centrally in said trailer, and said hook-rail structure is constructed to receive the respective hook structures in at least a pair of caddies, with such caddies disposed side-saddle on the laterally opposite sides of said rack-beam.

3. The system of claim 1, wherein said caddy includes a deck possessing accommodation structure adapted for lift-fork picking-up, raising and lowering, and moving, of the caddy, and a riser frame joined to the deck including elevated pick structure employable also for picking-up, raising and lowering, and moving, of the caddy.

4. The system of claim 3, wherein said deck is elongate, and includes opposite longitudinal ends and a lateral outer side, and said accommodation structure includes lift-fork receiving passages disposed at least adjacent both of said opposite ends and said lateral outer side.

5. A modular trailer/caddy load-handling system comprising
an elongate trailer having (a) a ground-traveling frame with a laterally central long axis, and (b) an elongate, upright, generally planar, load-supporting rack-beam structure joined to, and extending upwardly from, said frame, said rack-beam structure having a top portion, and lying substantially in a vertical plane which contains said long axis, and
a load-carrying caddy, removably dockable with said trailer via said top portion in said rack-beam structure on one lateral side of said plane, whereby any load carried by the caddy is delivered essentially laterally centrally and vertically to said trailer frame substantially entirely through said plane.

6. The system of claim 5, wherein said caddy includes gravity-operating hook structure, and removable caddy docking with said trailer via said top portion is accommodated by gravity-operated interaction between said hook structure and said top portion.

7. The system of claim 6, wherein said caddy is structured with a free-standing, separated-from-trailer, ground-support configuration whereby, when the caddy is removed from said trailer, it exhibits and implements a free, ground-standing capability.
